(19) United States
(12) Patent Application Publication
(10) Pub. No.: US 2024/0381843 A1
(43) Pub. Date: Nov. 21, 2024

(54) Animal Play Glove Device

(71) Applicants: Penny Barker, Modesto, CA (US); Leonard Barker, Modesto, CA (US)

(72) Inventors: Penny Barker, Modesto, CA (US); Leonard Barker, Modesto, CA (US)

(21) Appl. No.: 18/462,473

(22) Filed: Sep. 7, 2023

Related U.S. Application Data
(60) Provisional application No. 63/502,224, filed on May 15, 2023.

(51) Int. Cl. A01K 15/02

(52) U.S. Cl. CPC A01K 15/025; A41D 19/0024

(57) ABSTRACT

An animal play glove device is provided that allows a user to safely play with an animal such as, but not limited to, a cat. The device has a glove-like body that is designed to be worn on a user's hand during use. The body of the device further protects the fingers, hand, and arms of a user while playing with the animal. To do so, the body preferably encloses the fingers, hand, and upper (or in one embodiment, entire) arm of a user. At least one toy is attached to the body via at least one string.

### CROSS-REFERENCE TO RELATED APPLICATION

The present application claims priority to, and the benefit of, U.S. Provisional Application No. 63/502,224, which was filed on May 15, 2023, and is incorporated herein by reference in its entirety.

### FIELD OF THE INVENTION

The present invention relates generally to the field of animal toys. More specifically, the present invention relates to an animal play glove device that can be worn to protect a user's fingers, hand, and/or arm while playing with an animal via a toy of the device. Accordingly, the present disclosure makes specific reference thereto. Nonetheless, it is to be appreciated that aspects of the present invention are also equally applicable to other like applications, devices, and methods of manufacture.

### BACKGROUND

Many devoted pet owners thoroughly enjoy engaging in playful interactions with their cats or other animals using toys. However, inadvertent injuries to the pet owner can be caused by the sharp teeth and claws of said animals. In addition, the fear of getting bitten or scratched can, at times, create a barrier between pet owners and their animals. This is undesirable, as it may weaken or prevent a bond between a pet owner and a pet.

Therefore, there exists a long-felt need in the art for a device that can be worn while playing with an animal. More specifically, there exists a long-felt need in the art for an animal play glove device that can be worn while playing with an animal, wherein the device protects the user from being scratched or bitten by the animal. In addition, there exists a long-felt need in the art for an animal play glove device that can be worn while playing with an animal, wherein the device protects the user from being scratched or bitten by the animal while also providing a means for the user to play with the animal using the device.

The subject matter disclosed and claimed herein, in one embodiment thereof, comprises an animal play glove device. The device has a glove-like body that is designed to be worn on a user's hand during use wherein at least one toy of the device can be used to play with an animal, such as, but not limited to, a cat. The body of the device further protects the fingers, hands, and arms of a user while playing with the animal. To do so, the body preferably encloses the fingers, hand, and upper (or in one embodiment, entire) arm of a user.

In this manner, the animal play glove device of the present invention accomplishes all the foregoing objectives and provides a device that can be worn while playing with an animal. While doing so, the device protects the user from being scratched or bitten by the animal. In addition, the device provides a means for the user to play with the animal using the device via the toys attached to the body via strings.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal play glove device. The device is designed to be worn on a user's hand during use wherein at least one toy of the device can be used to play with an animal, such as, but not limited to, a cat. The body of the device further protects the fingers, hands, and arms of a user while playing with the animal.

The body preferably encloses the fingers, hand, and upper (or in one embodiment, entire) arm of a user. The body is preferably made from a material that cannot be easily penetrated by the teeth/claws of an animal to provide the user's body protection while wearing the device. In addition, any area of the body may be comprised of additional internal and/or external padding.

The body has at least one finger which encloses at least one finger of the user. A first end of at least one string attaches to the finger. A second end of the string then attaches to at least one toy. As a result, the toy is suspended from the body and can be moved via movement of the user's hand/arm while wearing the device to play with the animal using the toy. In one embodiment, the first end is fixedly attached to the tip of the finger. In another embodiment, the first end may removably attach to the tip. This allows a user to easily replace strings if they become broken (i.e., by the animal) or otherwise become worn.

Similarly, at least one toy may fixedly or removably attach to the second end of the string. This allows a user to easily replace the toy if it became broken (i.e., by the animal) or otherwise becomes worn. The toy may be any animal toy known in the art.

The present invention is also comprised of a first method of using the device. First, a device is provided comprised of a body comprised of at least one string, wherein at least one toy is attached to the string. Then, a user can place the body around their fingers, hand, and/or arm. Next, a user can play with an animal by moving their fingers, hand, and/or arm which in turn moves the string and the toy attached to the string.

The present invention is also comprised of a second method of using the device. First, a device is provided comprised of a body comprised of at least one string, wherein at least one toy is attached to the string. Then, a user can place the body around their fingers, hand, and/or arm. Then, a user can attach at least one toy to a second end of the string using at least one fastener of the second end and/or the fastener of the toy. Next, a user can play with an animal by moving their fingers, hand, and/or arm which in turn moves the string and the toy attached to the string.

The present invention is also comprised of a third method of using the device. First, a device is provided comprised of a body comprised of at least one string, wherein at least one toy is attached to the string. Then, a user can place the body around their fingers, hand, and/or arm. Next, a user can attach the first end of the string to the finger (and in one embodiment, the tip of the finger) using at least one fastener of the first end and/or the fastener of the finger. Then, a user can attach at least one toy to a second end of the string using at least one fastener of the second end and/or the toy. Next, a user can play with an animal by moving their fingers, hand, and/or arm which in turn moves the string and the toy attached to the string.

Accordingly, the animal play glove device of the present invention is particularly advantageous as it provides a device that can be worn while playing with an animal. In addition, the device protects the user from being scratched or bitten by the animal. During use, the various toys of the device provide a means for the user to play with the animal using the device. In this manner, the animal play glove device provides a solution to user protection while playing with an animal, while also providing the user with a new way of playing with said animal.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal play glove device of the present invention in accordance with the disclosed architecture;

FIG. 2 illustrates an enhanced perspective view of one potential embodiment of an animal play glove device of the present invention in accordance with the disclosed architecture;

FIG. 3 illustrates a flowchart of a method of using one potential embodiment of an animal play glove device of the present invention in accordance with the disclosed architecture;

FIG. 4 illustrates a flowchart of a method of using one potential embodiment of an animal play glove device of the present invention in accordance with the disclosed architecture; and

FIG. 5 illustrates a flowchart of a method of using one potential embodiment of an animal play glove device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be worn while playing with an animal. More specifically, there exists a long-felt need in the art for an animal play glove device that can be worn while playing with an animal, wherein the device protects the user from being scratched or bitten by the animal. In addition, there exists a long-felt need in the art for an animal play glove device that can be worn while playing with an animal, wherein the device protects the user from being scratched or bitten by the animal while also providing a means for the user to play with the animal using the device.

The present invention, in one exemplary embodiment, is comprised of an animal play glove device designed to be worn on a user's hand during use wherein at least one toy of the device can be used to play with an animal, such as, but not limited to, a cat. The body of the device further protects the fingers, hand, and arms of a user while playing with the animal. To do so, the body preferably encloses the fingers, hand, and upper (or in one embodiment, entire) arm of a user. The body is preferably made from a material that cannot be easily penetrated by the teeth/claws of an animal to provide the user's body protection while wearing the device. In addition, any area of the body may be comprised of additional internal and/or external padding.

The body has at least one finger which encloses at least one finger of the user. A first end of at least one string attaches to the finger. A second end of the string then attaches to at least one toy. As a result, the toy is suspended from the body and can be moved via movement of the user's hand/arm while wearing the device to play with the animal using the toy. In one embodiment, the first end is fixedly attached to the tip of the finger. In another embodiment, the first end may removably attach to the tip. This allows a user to easily replace strings if they become broken (i.e., by the animal) or otherwise become worn. Similarly, at least one toy may fixedly or removably attach to the second end of the string. This allows a user to easily replace the toy if it became broken (i.e., by the animal) or otherwise becomes worn. The toy may be any animal toy known in the art.

The present invention is also comprised of a first method of using the device. First, a device is provided comprised of a body comprised of at least one string, wherein at least one toy is attached to the string. Then, a user can place the body around their fingers, hand, and/or arm. Next, a user can play with an animal by moving their fingers, hand, and/or arm which in turn moves the string and the toy attached to the string.

The present invention is also comprised of a second method of using the device. First, a device is provided comprised of a body comprised of at least one string, wherein at least one toy is attached to the string. Then, a user can place the body around their fingers, hand, and/or arm. Then, a user can attach at least one toy to a second end of the string using at least one fastener of the second end and/or the fastener of the toy. Next, a user can play with an animal by moving their fingers, hand, and/or arm which in turn moves the string and the toy attached to the string.

The present invention is also comprised of a third method of using the device. First, a device is provided comprised of a body comprised of at least one string, wherein at least one toy is attached to the string. Then, a user can place the body around their fingers, hand, and/or arm. Next, a user can attach the first end of the string to the finger (and in one embodiment, the tip of the finger) using at least one fastener of the first end and/or the fastener of the finger. Then, a user can attach at least one toy to a second end of the string using at least one fastener of the second end and/or the toy. Next, a user can play with an animal by moving their fingers, hand, and/or arm which in turn moves the string and the toy attached to the string.

Accordingly, the animal play glove device of the present invention is particularly advantageous as it provides a device that can be worn while playing with an animal. In addition, the device protects the user from being scratched or bitten by the animal. During use, the various toys of the device provide a means for the user to play with the animal using the device. In this manner, the animal play glove device provides a solution to user protection while playing with an animal, while also providing the user with a new way of playing with said animal.

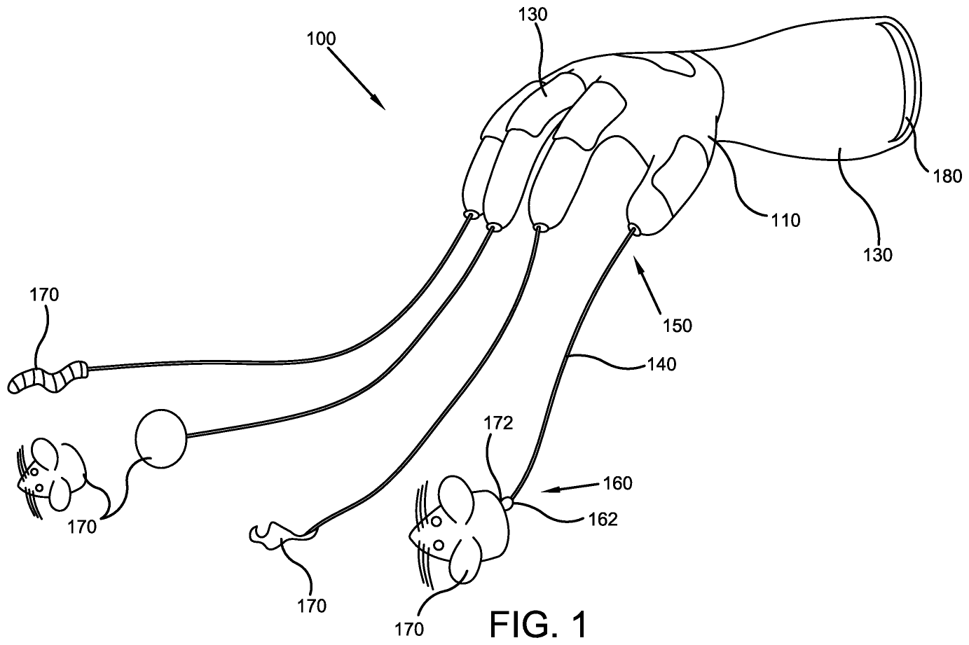

Referring initially to the drawings, FIG. 1 illustrates a perspective view of one potential embodiment of an animal play glove device 100 of the present invention in accordance with the disclosed architecture. The device 100 is designed to be worn on a user's hand during use. While in use, at least one toy 170 (which attaches to at least one finger 120 of the body 110 via at least one string 140) can be used to play with an animal, such as, but not limited to, a cat. The body 110 of the device 100 further protects the fingers, hands, and arms of a user while playing with the animal.

The body 110 preferably encloses the fingers, hand, and upper (or in one embodiment, entire) arm. The body 110 is preferably made from a material that cannot be easily penetrated by the teeth/claws of an animal to provide the user's body protection while wearing the device 100. Said material includes, but is not limited to, jute, leather, vinyl, polyester, ripstop, cordura, etc. The body 110 may be made from a smooth material that cannot snag on the teeth/claws of an animal such as, but not limited to, microfiber, performance fabric, knit fabric, fleece, neoprene, ripstop, etc.

In addition, any area of the body 110 may be comprised of additional internal and/or external padding 130. The padding 130 may be any type known in the art such as, but not limited to, foam, rubber, etc. The padding 130 further protects the user's body parts from being penetrated by the claws or teeth of an animal the device 100 is used to play with.

In order to secure the device 100 around a user's arm/hand/wrist/fingers, any portion of the body 110 may be comprised of at least one fastener 180. The fastener 180 may allow a user to tighten/loosen the device 100 around their body. The fastener 180 may include, but is not limited to, an elastic fastener, a hook and loop fastener, a snap button fastener, a drawstring fastener, etc.

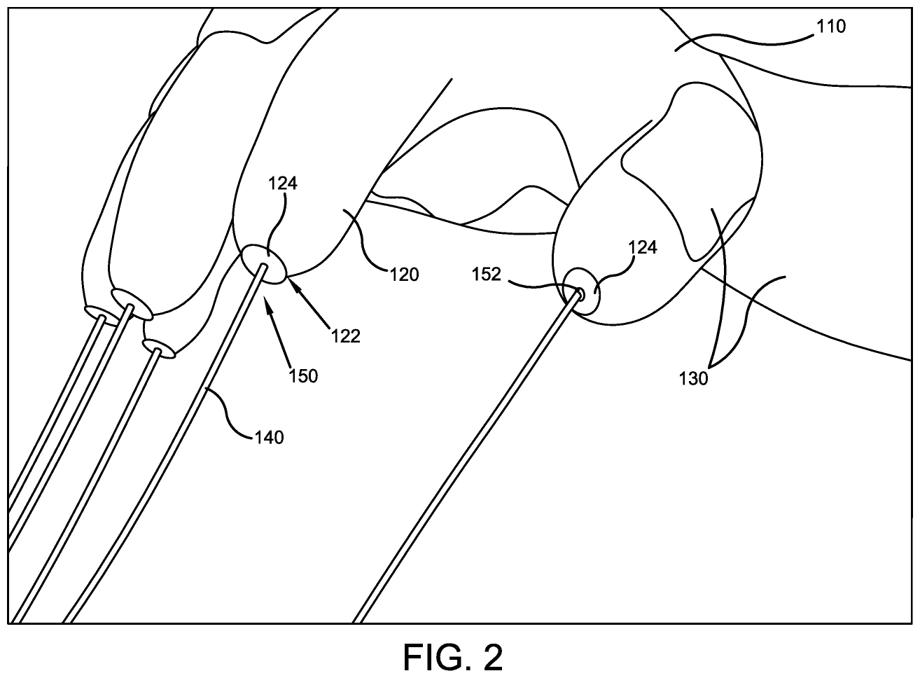

The body 110 has at least one finger 120 which encloses at least one finger of the user. A first end 150 of at least one string 140 attaches to the finger 120, as seen in FIG. 2. A second end 160 of the string 140 then attaches to at least one toy 170. As a result, the toy 170 is suspended from the body 110 and can be moved via movement of the user's hand/arm while wearing the device 100 to play with the animal using the toy 170.

The string 140 may be any type of string/line known in the art. This includes, but is not limited to, twine, sisal rope, elastic cord, fishing line, felt, polyester, etc. In one embodiment, the first end 150 is fixedly attached to the tip 122 of the finger 120. In another embodiment, the first end 150 may removably attach to the tip 122. In this embodiment, the tip 122 may be comprised of at least one fastener 124. The fastener 124 may engage at least one fastener 152 of the first end 150 of the string 140, or just the first end 150. The fasteners 124,152 are preferably reciprocating fasteners such as, but not limited to, hook and loop, snap button, male and female, etc. This allows a user to easily replace strings 140 if they become broken (i.e., by the animal) or otherwise become worn.

Similarly, at least one toy 170 may fixedly or removably attach to the second end 160 of the string 140. In a removable embodiment, the toy 170 may be comprised of at least one fastener 172. The fastener 172 may engage at least one fastener 162 of the second end 160 of the string 140, or just the second end 160. The fasteners 124,162 are preferably reciprocating fasteners such as, but not limited to, hook and loop, snap button, male and female, etc. This allows a user to easily replace the toy 170 if it became broken (i.e., by the animal) or otherwise becomes worn. The toy 170 may be any animal toy known in the art. This includes, but is not limited to, interactive toys, feather toys, ball toys, plush toys, catnip toys, scratching toys, bouncing toys, elastic toys, bell toys, crinkle toys, spring toys, wand toys, ribbon toys, chew toys, scented toys, etc.

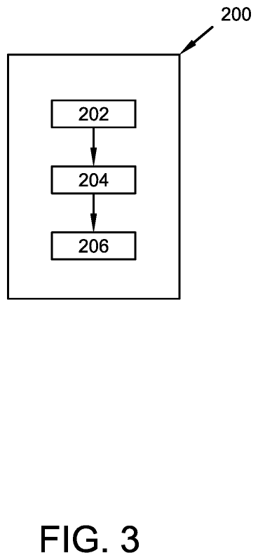

The present invention is also comprised of a method of using 200 the device 100, as seen in FIG. 3. First, a device 100 is provided comprised of a body 110 comprised of at least one string 140 that attaches to the body 110, wherein at least one toy 170 is attached to the string 140 [Step 202]. Then, a user can place the body 110 around their fingers, hand, and/or arm [Step 204]. Next, a user can play with an animal by moving their fingers, hand, and/or arm which in turn moves the string 140 and the toy 170 attached to the string 140 [Step 206].

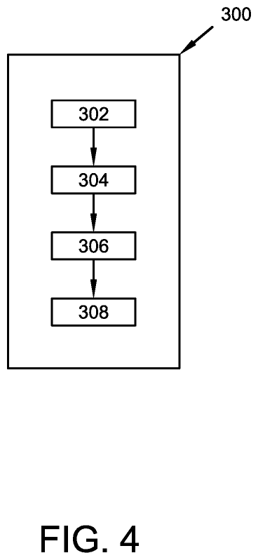

The present invention is also comprised of a second method of using 300 the device 100, as seen in FIG. 4. First, a device 100 is provided comprised of a body 110 comprised of at least one string 140 that attaches to the body 110, wherein at least one toy 170 is attached to the string 140 [Step 302]. Then, a user can place the body 110 around their fingers, hand, and/or arm [Step 304]. Then, a user can attach at least one toy 170 to a second end 160 of the string 140 using at least one fastener 162 of the second end 160 and/or the fastener 172 of the toy 170 [Step 306]. Next, a user can play with an animal by moving their fingers, hand, and/or arm which in turn moves the string 140 and the toy 170 attached to the string 140 [Step 308].

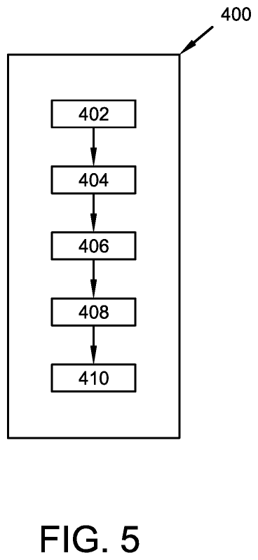

The present invention is also comprised of a third method of using 400 the device 100, as seen in FIG. 5. First, a device 100 is provided comprised of a body 110 comprised of at least one string 140 that attaches to the body 110, wherein at least one toy 170 is attached to the string 140 [Step 402]. Then, a user can place the body 110 around their fingers, hand, and/or arm [Step 404]. Next, a user can attach the first end 150 of the string 140 to the finger 120 (and in one embodiment, the tip 122 of the finger 120) using at least one fastener 152 of the first end 152 and/or the fastener 124 of the finger 120 [Step 406]. Then, a user can attach at least one toy 170 to a second end 160 of the string 140 using at least one fastener 162 of the second end 160 and/or the toy 172 [Step 408]. Next, a user can play with an animal by moving their fingers, hand, and/or arm which in turn moves the string 140 and the toy 170 attached to the string 140 [Step 410].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “animal play glove device” and “device” are interchangeable and refer to the animal play glove device 100 of the present invention.

Notwithstanding the foregoing, the animal play glove device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal play glove device 100 as shown in the FIGS. are for illustrative purposes only, and that many other sizes and shapes of the animal play glove device 100 are well within the scope of the present disclosure. Although the dimensions of the animal play glove device 100 are important design parameters for user convenience, the animal play glove device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal play glove device comprising:
a body comprised of a finger;
a string attached to the finger; and
a toy attached to the string.

2. The animal play glove device of claim 1, wherein the body is comprised of a padding.

3. The animal play glove device of claim 1, wherein the body is made from a smooth material.

4. The animal play glove device of claim 1, wherein the body is made from a jute, a leather, a vinyl, a polyester, a ripstop, or a cordura material.

5. The animal play glove device of claim 2, wherein the padding is comprised of a foam or a rubber padding.

6. The animal play glove device of claim 2, wherein the padding is positioned on an exterior of the body.

7. The animal play glove device of claim 2, wherein the padding is positioned on an interior of the body.

8. The animal play glove device of claim 1, wherein the toy is comprised of an interactive toy, a ball toy, a feather toy, a plush toy, a catnip toy, a scratching toy, a bouncing toy, an elastic toy, a bell toy, a crinkle toy, a spring toy, a wand toy, a ribbon toy, a chew toy, or a scented toy.

9. An animal play glove device comprising:
a body comprised of a finger;
a string removably attached to the finger; and
a toy removably attached to the string.

10. The animal play glove device of claim 9, wherein a first end of the string is comprised of a first fastener.

11. The animal play glove device of claim 10, wherein the finger is comprised of a second fastener that receives the first fastener.

12. The animal play glove device of claim 9, wherein a second end of the string is comprised of a third fastener.

13. The animal play glove device of claim 10, wherein the toy is comprised of a fourth fastener that receives the third fastener.

14. The animal play glove device of claim 9 further comprised of a fifth fastener.

15. The animal play glove device of claim 14, wherein the fifth fastener allows the body to tighten/loosen.

16. The animal play glove device of claim 15, wherein the fifth fastener is comprised of an elastic fastener, a hook and loop fastener, a snap button fastener, or a drawstring fastener.

17. The animal play glove device of claim 9, wherein the toy is comprised of an interactive toy, a ball toy, a feather toy, a plush toy, a catnip toy, a scratching toy, a bouncing toy, an elastic toy, a bell toy, a crinkle toy, a spring toy, a wand toy, a ribbon toy, a chew toy, or a scented toy.

18. A method of using an animal play glove device, the method comprising the following steps:
providing an animal play glove device comprised of a body comprised of a string that attaches to the body, wherein a toy attaches to the string;
placing the body around a finger, a hand, or an arm; and
playing with an animal by moving the body, which moves the toy attached to the string.

19. The method of using an animal play glove device of claim 18 further comprised of a step of attaching the string to the body using a first fastener and a second fastener.

20. The method of using an animal play glove device of claim 18 further comprised of a step of attaching the string to the toy to the string via a third fastener and a fourth fastener.
